(19) United States
(12) Patent Application Publication
(10) Pub. No.: US 2025/0239641 A1
(43) Pub. Date: Jul. 24, 2025

(54) LITHIUM DISPENSER SYSTEM FOR MANUFACTURING OF AN ELECTRODE

(71) Applicant: Solid Power Operating, Inc., Louisville, CO (US)

(72) Inventors: A YANG, Erie, CO (US); Sikandar IQBAL, Louisville, CO (US); Brandon KELLY, Longmont, CO (US)

(21) Appl. No.: 18/986,218

(22) Filed: Dec. 18, 2024

Related U.S. Application Data
(60) Provisional application No. 63/614,269, filed on Dec. 22, 2023.

(51) Int. Cl. H01M 10/04; H01M 4/04; H01M 4/136; H01M 50/403; H01M 50/411; H01M 50/46

(52) U.S. Cl. CPC H01M 10/0404; H01M 4/0435; H01M 4/136; H01M 50/403; H01M 50/411; H01M 50/46; H01M 2300/0068

(57) ABSTRACT

Systems and methods for utilizing one or more spools and/or rollers for the gentle application of a lithium layer onto a separator layer in an electrode stack of a solid-state battery cell to prevent or minimize damage to the conductive layer. In one embodiment, a feeder spool of provides a conductive foil and interleaf stack combination to an application roller. The application roller may then apply the conductive foil onto a separator layer of the electrode stack. An interleaf rewind spool may collect the remaining interleaf material from the conductive foil/interleaf combination once the conductive foil is deposited onto the separator layer. The conductive foil may adhere to the separator layer through a combination of a gravity force pressing the conductive foil and/or surface energy between the conductive foil and the SSE layer, thereby allowing the interleaf rewind spool to pull the interleaf material from the combination.

### CROSS-REFERENCE TO RELATED APPLICATION

This application is related to and claims priority under 35 U.S.C. § 119(e) from U.S. Patent Application No. 63/614,269, filed Dec. 22, 2023 titled “Lithium Dispenser System for Manufacture of an Electrode,” the entire contents of which is incorporated herein by reference for all purposes.

### TECHNICAL FIELD

Various embodiments described herein relate to the field of solid-electrolyte containing primary and/or secondary electrochemical cells, separators, electrodes, and electrode materials, and the corresponding methods of making and using the same.

### BACKGROUND AND INTRODUCTION

The evolution of hybrid and electric automobiles and other battery powered vehicles, and more generally battery-powered devices, is creating needs for battery technologies with improved reliability, capacity, thermal characteristics, lifetime, and recharge performance, among other things. Currently, although lithium-based and other solid-state battery technologies offer potential improvements in safety, packaging efficiency, and enable new high-energy chemistries as compared to other types of batteries, improvements in lithium-based and other solid-state battery technologies are needed, including advances in high volume production and cost reductions to the same.

It is with these observations in mind, among others, that various aspects of the present disclosure were conceived.

### SUMMARY

One aspect of the present disclosure relates to a system for manufacturing a battery electrode. The system including a feeder spool containing a conductive foil layer and an interleaf layer, an application roller receiving the conductive foil layer and the interleaf layer from the feeder spool, the application roller applying the conductive foil layer onto a solid-state electrolyte (SSE) layer of an electrode stack, and a rewind spool containing the remaining interleaf layer after the conductive foil layer is applied onto the SSE layer. The conductive foil is deposited onto the SSE layer through a gravitational force on the conductive layer and/or a surface energy between the conductive foil layer and the SSE layer, the rewind spool providing a pulling force to remove the interleaf layer as the conductive layer is deposited onto the SSE layer by the application roller.

Another aspect of the present disclosure relates to a method for manufacturing a battery electrode. The method may comprise the operations of feeding an interleaf layer comprising a polymer material from a feeder spool, around an application roller, and to a rewind spool, the feeder spool containing a conductive foil layer and the interleaf layer in a layered configuration, rotating the rewind spool to generate a pulling force on the interleaf layer to apply, at the application roller, the conductive foil layer onto a solid-state electrolyte (SSE) layer of an electrode stack through a gravitational force on the conductive layer and/or a surface energy between the conductive foil layer and the SSE layer, the pulling force removing the interleaf layer as the conductive layer is deposited onto the SSE layer by the application roller, and passing, while rotating the rewind spool, the conductive foil layer and the SSE layer through a pressing device.

### BRIEF DESCRIPTION OF THE DRAWINGS

FIGS. 1A and 1B are diagrams illustrating manufacturing a solid-electrolyte containing electrode laminate using a conductive layer applicator, according to aspects of the present disclosure.

FIG. 2 is a flowchart of a method for manufacturing a solid-electrolyte containing electrode laminate using a conductive layer applicator, according to aspects of the present disclosure.

FIG. 3 is a diagram illustrating an example of a computing system which may be used in implementing embodiments of the present disclosure.

### DETAILED DESCRIPTION

Lithium-based rechargeable batteries are popular to power many forms of modern electronics and have the capability to serve as the power source for hybrid and fully electric vehicles. Traditional electrode manufacturing for lithium-based rechargeable batteries can be a time-consuming and inefficient process, however. To manufacture a graphite anode, for example, a graphite slurry is produced that includes graphite components, binders, and some kind of solvent that is then applied to a metal foil, such as a copper foil, by a process of extrusion, rolling, or tape-casting, depending on selected process and solvents used. After application, the coated graphite mixture is dried by evaporation of solvents, such as by running the coated slurry through an oven or other drying machine. Cathode construction may occur in a similar manner with an aluminum foil used.

In an alternate approach, the electrode may be comprised of solid-state components layered in an electrode configuration. In particular, an electrode laminate for a battery may include a solid-state separator layer in place of a traditional separator layer/liquid electrolyte used in conventional liquid electrolyte battery architectures. Typical solid-state separator layers use some type of polyethylene material with a ceramic coating to separate the anode from the cathode and prevent shorts within the battery. The stack electrode may also include the solid-state electrolyte separator layer to allow the flow of electrons between the cathode and anode through the layer, without the use of a liquid electrolyte. Regardless, each of the multiple steps to produce the battery stack may introduce inefficiencies or opportunities for flaws to in the battery design, resulting in shorter battery life or potential for a short within the battery itself. For example, one or more layers of the battery stack may be quite delicate and may tear or break if handled roughly during construction of the electrode stack. These tears or breakages within the layers of the electrode stack can lead to an inefficient battery. As such, tremendous care is typically required in the manufacturing and handling of battery electrodes to prevent damaging one or more layers of the electrode stack.

The term “battery” in the art and herein can be used in various ways and may refer to an individual cell having an anode and cathode separated by an electrolyte, solid or liquid, as well as a collection of such cells connected in various arrangements. A battery or battery cell is a form of electrochemical device. Batteries generally comprise repeating units of sources of a countercharge and electrode layers separated by an ionically conductive barrier, often a liquid or polymer membrane saturated with an electrolyte. These layers are made to be thin so multiple units can occupy the volume of a battery cell, increasing the available power of the battery cell with each stacked unit. Although many examples are discussed herein as applicable to a battery cell, it should be appreciated that the systems and methods described may apply to many different types of batteries ranging from an individual cell to batteries involving different possible interconnections of cells, such as cells coupled in parallel, series, and parallel and series. For example, the systems and methods discussed herein may apply to a battery pack comprising numerous cells arranged to provide a defined pack voltage, output current, and/or capacity. Moreover, the implementations discussed herein may apply to different types of electrochemical devices such as various different types of batteries and solid-state batteries of various possible chemistries, to name a few. The various implementations discussed herein may also apply to different structural battery cell arrangements such as button or “coin” type batteries, cylindrical battery cells, pouch battery cells, and prismatic battery cells.

Aspects of the present disclosure involve systems and methods of producing an electrode, which may be for a battery that includes a solid-electrolyte separator layer. Further, the present disclosure involves systems and methods for reducing or preventing damage to one or more of the layers within the electrode stack, which may include one or more anode layers, one or more cathode layers, one or more solid-electrolyte separator layers, etc., during the manufacturing process. For example, a layer of lithium material may be used as a conductive layer of the stack. However, such a lithium layer may be very fragile and susceptible to tearing, breaking, or other damage during the manufacturing process (e.g., the layering of materials to create the electrode stack). To address the observed instabilities of solid-state electrode manufacturing, aspects of the present disclosure involve utilizing one or more spools and/or rollers for the gentle application of a lithium layer onto a separator layer in an electrode stack of a solid-state battery cell to prevent or minimize damage to the fragile conductive layer. Further, although described herein as applying to a lithium layer, it should be appreciated that the systems and methods discussed herein may apply to any material or layer of a battery cell. The system including spools and/or rollers described herein may reduce one or more pulling forces on a fragile layer of the electrode stack (such as a lithium conductive layer) during manufacturing to protect the layer from tearing or suffering other mechanical flaws in the layer. The electrode laminate discussed herein may then be utilized in any type of battery or electrochemical cell, including solid state, semi-solid state, or liquid-based batteries.

In one example, an electrode of a battery may comprise a stack of a center electrode layer or layers between two layers of a solid-state electrolyte (SSE) material. However, in some implementations, the conductive center electrode foil may be comprised of a fragile material that may be damaged or tear easily when manipulated. Thus, application of the conductive center electrode onto or between the SSE layer may include a process that reduces the manipulation and forces applied to the layer. In one instance, application of the conductive foil within the conductive stack may include rolling the foil onto an SSE layer by a gentle roller applicator while reducing or minimizing a pulling force on the conductive foil as compared to some previous implementations.

In particular, a feeder spool of alternating layers of a lithium or lithium alloy foil and a polymer interleaf material may be unrolled to provide the conductive foil and interleaf stack combination to an application roller. The application roller may then roll or otherwise apply the conductive foil onto an SSE layer of the electrode stack prior to the SSE layer being passed through a calender or other pressing device (generally utilized to densify or laminate one or more of the layers of the electrode, including the center conductive foil layer). An interleaf rewind spool may collect the remaining interleaf material from the conductive foil/interleaf combination once the conductive foil is deposited onto the SSE layer. In some instances, the interleaf rewind spool may be controlled or otherwise rotated to gently pull the interleaf material away from the conductive foil once the foil comes into contact or is otherwise deposited onto the SSE layer. The conductive foil may adhere to the SSE layer through a combination of a gravity force pressing the conductive foil onto the SSE layer and/or surface energy between the conductive foil and the SSE layer, thereby allowing the interleaf rewind spool to pull the interleaf material from the combination. The control of the rotation of the interleaf rewind spool may be such as to provide enough of a pulling force to rotate the feeder spool and the application roller without ripping or tearing the conductive foil as the foil is rolled onto the corresponding SSE layer. Through this combination of spools and rollers, a constant application of the conductive foil into the electrode stack may be accomplished that reduces the likelihood of tearing of the conductive foil during the manufacturing process.

These and other manufacturing systems and methods are described herein for generating a solid-electrolyte containing electrode laminate for use in a battery configuration.

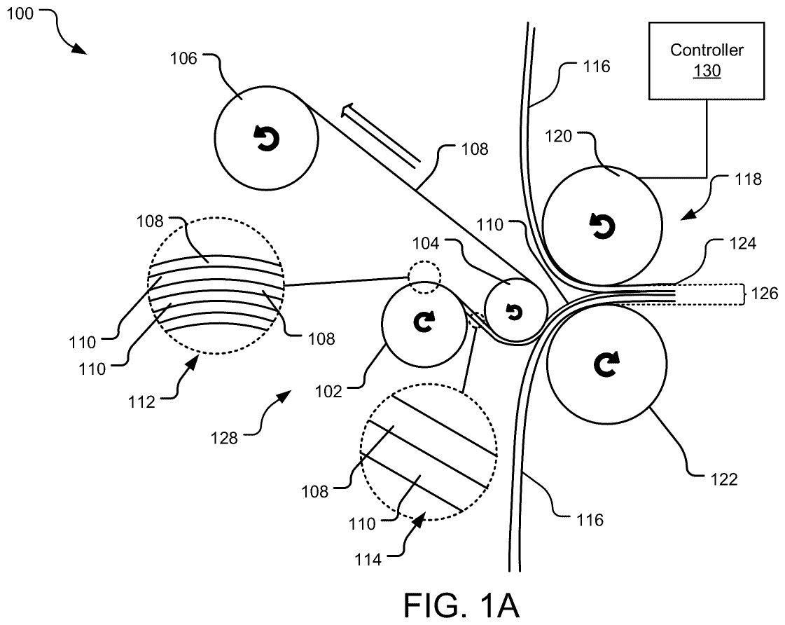

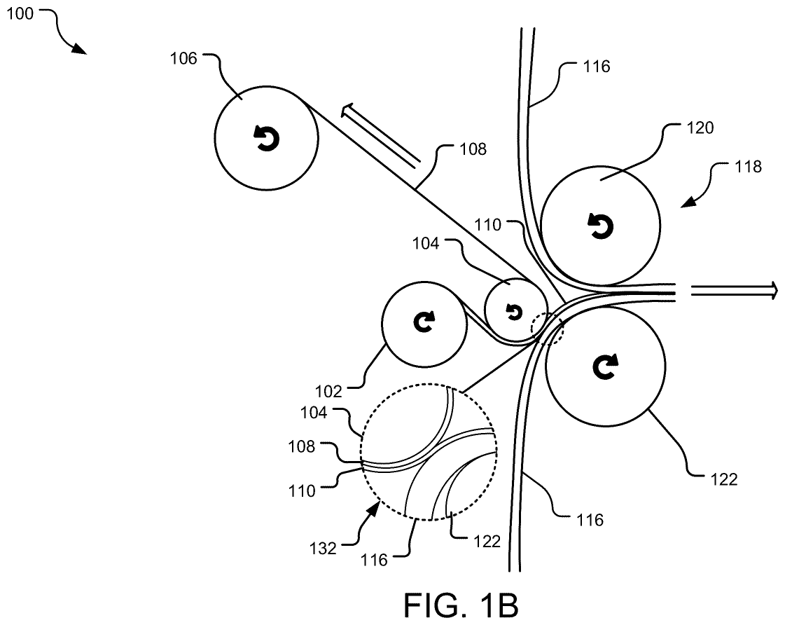

FIG. 1A is a diagram 100 illustrating a system for manufacturing a first solid-electrolyte containing electrode laminate 124 using a calender press device 118 and a conductive layer applicator system 128, according to aspects of the present disclosure. In one implementation, the solid-electrolyte containing electrode laminate 124 may include two separator layers of a composite blend of a solid-state electrolyte (SSE) 116 and a binder between which a conductor layer 110 may be applied. The SSE 106 may also be referred to and considered a separator or separator layer. In one implementation, the conductor (electrode) layer 110 of the electrode stack 124 may comprise a lithium foil layer, although other metal or metal composites are contemplated. Regardless of the composition, the center conductor layer 110 may be applied between two facing SSE layers 116 to form at least a portion of a solid-electrolyte electrode 124 of a battery cell. In still other instances, the SSE layers 116 may be coated onto an outer foil (not shown) on one side and dried. In this configuration, the outer foil may be peeled from the electrode 124 after densifying and lamination through a pressing device 118, as described in more detail below.

To produce the solid-electrolyte electrode laminate 124 for the battery cell, two different sheets of the SSE 116 may be oriented such that the SSE layers are facing each other with the center conductor layer 110 between the two SSE sheets. When a lithium foil center conductor is positioned between SSE (separator) layers, the electrode stack may be considered a double separator sided anode. The formed electrode stack may then be used with additional cathode layers and current collectors in a battery cell, which may include multiple layers of such arrangements. The SSE layer 116 may comprise, in some implementations, a sulfide-based material. The SSE layer 116 may also include a binder solution and/or a solvent prepared in a slurry form that is mixed and dried. Each of the SSE layers 116 may be between 30-100 microns thick, although other thicknesses may be used. In one implementation, the center electrode 110 may include a lithium foil and the layers may be arranged in an [SSE-Lithium-SSE] stack. In other implementations, the center electrode may be a lithium alloy such as Li-Al (Lithium-Aluminum), Li-Mg (Lithium-Magnesium), Li-In ((Lithium-Indium). The lithium content of the center electrode alloys may be, in some examples, 5% to 99.9%, 10% to 99%, 20% to 98%, or 50% to 95%. In still another implementation, the center electrode may be a cathode comprising conductive materials, such as gold, silver, cadmium, etc. In general, any type of conductive material arranged in one or more layers may be utilized as the center electrode layer for the solid-electrolyte containing electrode.

In this implementation, the layers forming the electrode stack 124 are fed between the calender press 118 in an SSE-Lithium-SSE stack to laminate and/or densify the center electrode layer 110 (also referred to herein as the “conductive layer”) to the SSE layers 116. The calender press 118 may comprise a first roller 120 and a second roller 122 with a gap 126 between the rollers. As the electrode stack 124 is fed between the rollers 120, 122 through the gap 126 between the rollers, the rollers exert a force, which may be considered in some instances a compressive force, on the stack to press the layers together, thereby reducing the porosity of the materials within the stack (or increasing the density of the materials), enhancing material contact, and/or causing some layers to bond. In general, the respective rollers 120, 122 of the calender press 118 are spaced apart a distance less than the pre-calendered stack thickness such that pressure on the stack being fed between the calender rollers may reduce the porosity of the materials within the stack (thereby increasing the density of the SSE layers 116), enhance material contact between the layers, and/or cause the SSE layers to laminate or otherwise adhere to the center conductor layer 110.

The pressure applied to the stack 124 may correlate to a spacing 126 between the first roller 120 and the second roller 122, which may be adjustable by a controller 112, or manually prepositioned and adjustable. For example, one or both of the calender rollers 120, 122 of the press 118 may be adjustable to increase or decrease the spacing between the rollers based on the overall thickness of the electrode stack 124 or based on the thickness of one or more of the individual layers. The spacing 126 may be input to the controller 130, such as through a user input device connected to the controller, to set the spacing. In another implementation, one or more sensors may be associated with the calender press 118 and provide an output to the controller 130 which may control the spacing 126 in response. For example, the temperature of one or more of the layers of the electrode laminate 124 may affect the densification or adhesion of the layers. Thus, the temperature of the layers may be received from a sensor and the spacing of the rollers 120, 122 may be adjusted based on the received electrode temperature. Alternatively or in conjunction, the temperature of the rollers 120, 122 themselves may be adjusted or altered to change both the amount of densification of the layers of the electrode 124 and/or the adhesion of the layers. Other sensor inputs or other types of inputs may also be received at the controller 130 and used to adjust the calender spacing 126.

Application of the center electrode 110 onto the SSE layer or layers 116 of the electrode stack 124 may occur prior to the pressing of the stack by the calender press 118 such that the center electrode may be at least partially laminated to the SSE layers 116 of the stack. However, as mentioned above, the conductive foil 110 of the center electrode may be delicate and break or tear easily. Thus, the center electrode layer 110 may be applied to an SSE layer 116 of the electrode 124 through an application system 128 that may include unspooling a center electrode foil onto one of the SSE layers. FIGS. 1A and 1B illustrate the center foil application system 128 for applying a center electrode laminate onto an SSE layer 116. In the implementation shown, a feeder spool 102 may be oriented to rotate in a first direction to unspool a combination of center conductive foil 110 and an interleaf material 108. As shown in inset 112 of FIG. 1A, the feeder spool 102 may include a rolled stack of an interleaf material 108 and a conductor foil 110. In one implementation, the conductor foil 110 may comprise a lithium or lithium alloy foil, although other materials may be rolled with the interleaf 108 for inclusion in an electrode stack 124. As explained in more detail below, the conductor foil 110 of the feeder spool 102 may be applied to an SSE layer 116 for the electrode stack 124. The interleaf 108 may comprise a hydrocarbon based polymer material, such as Polypropylene. Generally, the interleaf 108 is used to separate the conductor foil 110 when rolled onto the feeder spool 102 and as a carrier of the conductor foil for application onto the SSE layer 116, as explained in more detail below. With the layered conductor foil 110 and interleaf 108 spooled onto the feeder spool 102, the spool may then be rotated to unspool the layered conductor foil/interleaf combination toward an application roller 104, as shown in inset 114 of FIG. 1A. In one implementation, application roller 104 may be positioned substantially vertically and to the left with regards to the lower roller 122 of the calender press 122 as application of the conductive foil 110 onto the SSE layer 116 is at least somewhat dependent on a gravity force. More particularly, the application roller 104 may be positioned such that the conductive foil 110 comes into contact with the SSE layer 116 as the application roller is rotated and the SSE layer is fed through the calender press 118. The application roller 104 may also be oriented to apply a small pressing force to press the conductive foil 110 against the SSE layer 116. A combination of a gravity force and a surface energy between the conductive foil and the SSE layer 116 may cause the conductive foil 110 to adhere to the SSE layer for passing through the calender press 118.

In general, however, the application roller 104 may have various orientations, sizes, and material for applying sufficient pressure to press the conductive foil 110 onto the SSE layer 116 for transfer of the conductive foil to the SSE layer. For example, the application roller 104 may be constructed of a stainless steel material or other hard material that provides a higher pressing force against the conductive foil 110 as the foil is pressed onto the SSE layer 116 by the roller. An application roller 104 constructed from a softer material, such as a silicon, may provide a lesser pressing force onto the conductive foil 110 at the point of transfer to the SSE layer 116 due to the pliability of the roller. An application roller 104 with a softer or more pliable material may be located more vertically with respect to the lower roller 122 of the calender press 118 than an application roller with a harder material. As explained in more detail below, the application roller 104 may apply the conductor foil 110, after separation from the interleaf 108, to an SSE layer 116 prior to the stack 124 being passed through the calender press 118. Although illustrated as being applied to the lower SSE layer 116, it should be appreciated that the conductor foil 110 may alternatively be applied to the upper SSE layer.

At the application roller 104, the conductor foil 110 is deposited onto the SSE layer 116. As the conductor foil 110 is placed on the corresponding SSE layer 116 by the application roller 104, the conductor foil is also separated from the interleaf 108. To avoid damage to the delicate foil 110, the combined interleaf and foil is withdrawn from the feeder spool 102 by pulling only on the interleaf 108. More particularly, the interleaf 108 may be attached to an interleaf rewind spool 106. The spool 106 is powered such that rotation of the interleaf rewind spool pulls the interleaf material 108 away from the conductor foil 110 as the foil is deposited onto the SSE layer 116. This has the effect of withdrawing the combined foil 110/interleaf 108 material from the feeder spool 102 without putting direct force on the delicate conductor foil 110. Where the foil 110 engages the SSE 116, the interleaf 108 is pulled away from the foil separating the interleaf from the foil and the interleaf is then collected at the rewind spool 106. As such, the rotation of the interleaf rewind spool 106 may aid in pulling the foil 110 from the feeder spool 102 while also separating the interleaf 108 from the conductor foil 110 in a manner that reduces or prevents tearing of the conductor foil for uniform (undamaged) application to the SSE layer 116. In one instance, the feeder spool 102 may rotate in a clockwise direction and the application roller 104 and the interleaf rewind spool 106 may rotate counter-clockwise. The feeder spool 102 and the application roller 104 are not necessarily powered because, as noted above, the material is withdrawn from the feeder spool 102 by way of the rewind spool 106 pulling only directly on the interleaf 108. Thus, the feeder spool 102 and the application roller 104 may be allowed to rotate freely in response to the rotation of the interleaf rewind spool 106. In one implementation, the speed at which the rewind spool rotates may be related to the rotation speed of either the calendar rollers 120,122 and/or the feeder spool 102 to ensure that the components of the stack do not bunch up prior to entering the calendar press 118. In general, the rewind spool 106 may be controlled to maintain a continuous feed of the foil onto the SSE layer as the SSE layer is pulled through the calendar press 118 such that the rotation speed of the rewind spool is based on the speed of the combined electrode through the calendar press. In some particular examples, the linear speed of the foil 110 may be 1 meter/min up to 100 meters/min.

Inset 132 of FIG. 1B illustrates the transfer of the conductive foil 110 from the interleaf 108/conductive foil combination at the application roller 104 onto the SSE layer 116. As shown, the application roller 104 may press or otherwise cause the conductive layer 110 to come into contact with the SSE layer 116 prior to the electrode stack 124 passing between the upper roller 120 and the lower roller 122 of the calender press 118. In general, the conductive foil 110 may have some naturally occuring adhesion to the interleaf 108 that allows for the conductive foil to stick to the interleaf during the unwinding of the interleaf 208/conductive foil combination from the feeder spool 102. At the point where the conductive foil 110 comes into contact with the SSE layer 116, the application roller 104, using the force of gravity and a surface adhesion between the conductive foil and the corresponding SSE layer, may deposit the conductive layer onto the SEE layer. The conductive foil 110 may adhere to the SSE layer 116 with a surface energy that is more than the surface energy between the conductive foil and the interleaf 108, which causes the conductive foil 110 to separate from the interleaf 108 and adhere to the SSE layer. The conductive foil 110, now adhered to one of the SSE layers 116, is pulled between the calender rollers 120, 122, where the stack 124 is laminated to form an SSE (separator)-Lithium (anode)-SSE (separator) electrode stack. In some instances, the SSE layer 116 may also include an outer foil layer such that the process forms an Outer foil-SSE-Lithium-SSE-Outer foil stack. Through the use of the spools and rollers, the conductive foil 110 is therefore applied to the electrode stack 124 while minimizing damage to the fragile conductive foil during the application of the conductive foil onto the SSE layers 116 of the stack.

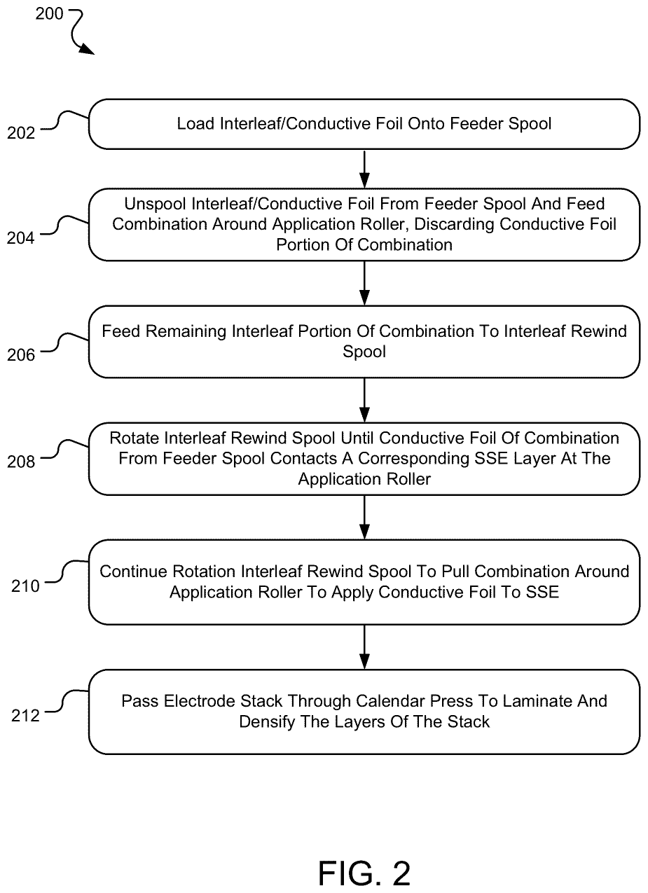

FIG. 2 is a flowchart of a method 200 for manufacturing a solid-electrolyte containing electrode laminate using a conductive layer applicator, according to aspects of the present disclosure. The method 200 may be used to apply the conductive layer 110 in the electrode stack 124 in a manner that reduces a mechanical strain on the fragile conductive layer to prevent or reduce damage to the foil. At step 202, the feeder spool 102 may be loaded with an interleaf 108/conductive foil 110 combination by winding the combination onto the feeder spool such that the spool includes a stack of alternating interleaf layers and conductor foil layers. Once the feeder spool 102 is loaded with enough interleaf 108/conductive foil 110 to manufacture a desired amount of electrode stack 124, the feeder spool 102 may be unwound and the interleaf 108/conductive foil 110 combination may be fed around the application roller 104 at step 204 and to the interleaf rewind spool 106 at step 206. During this initial phase, a portion of the conductive foil 110 may be removed from the interleaf 108/conductive foil 110 combination pulled from the feeder spool 102. In particular, the conductive foil 110 is meant to be separated from the interleaf 108 at the application roller 104 to allow for the interleaf to reach around the application roller and to start being rewound onto the interleaf rewind spool 106. Thus, a portion of the conductive foil 110 may be discarded to allow a separated portion of the interleaf layer 108 to be wound around the application roller 104 and onto the interleaf rewind spool 106. As such, a portion of the conductive foil 110 may be discarded sufficiently to feed the conductive foil 110 to the application roller 104 without being fed to the interleaf rewind spool 106.

In another implementation, the feeder spool 102 may be loaded with an interleaf 108/conductive foil 110 combination that includes several meters (or some other sufficient length) of the interleaf layer at the end of the spool that can be pulled from the feeder spool before a conductive foil is exposed. In the manner as described above, the single interleaf layer 108 at the end of the feeder spool 102 may be sufficient to feed the interleaf layer around the application roller 104 and wound around the interleaf rewind spool 106 to begin the process of pulling the combination of interleaf 108/conductive foil 110 from the feeder spool. Regardless of if the conductive foil layer is removed or if the feeder spool 102 is loaded with a portion of a single interleaf layer 108 at the end of the feeder spool, enough interleaf layer may be fed to the interleaf rewind spool 106 to provide a tension on the interleaf layer to rotate the feeder spool 102 and/or the application roller 104.

At step 208, the interleaf rewind spool 106 may be rotated to begin to spool the interleaf layer 108 onto the spool while pulling the interleaf 108/conductive foil 110 from the feeder spool 102 around the application roller 104. As explained above, as the interleaf 108/conductive foil 110 combination is pulled around the application roller 104, the conductive foil layer may contact a corresponding SSE layer 116 prior to being passed through the calender press 118. More particularly, the rollers 120, 122 of the calender press 118 may be rotated at the same time that the interleaf rewind spool 106 is rotated such that the conductive foil 110 may be applied to the corresponding SSE layer 116 as the SSE layer is fed into the calender press. The rotation of the interleaf rewind spool 106 causes a pulling force on the interleaf layer 108, which in turn causes rotation of the application roller 104 and the feeder spool 102. As also explained above, at the point where the conductive foil 110 comes into contact with the SEE layer 116, the application roller 104, through gravity and an adhesion property or surface energy between the conductive layer 110 and the SSE layer 116, may deposit the conductive layer onto the SEE layer. The conductive foil 110 may adhere to the SSE layer 116 with a surface energy that is more than the surface energy between the conductive foil and the interleaf 108, which causes the conductive foil 110 to separate from the interleaf. The conductive foil 110, now adhered to one of the SSE layers 116, is passes through the calender rollers 120, 122, where the stack 124 is laminated to form a densified SSE-Conductive Layer-SSE electrode stack. The application of the conductive foil 110 onto the SSE layer 106 may therefore occur through the pulling tension on the interleaf layer 108 and not the conductive layer 110. Rather, the conductive foil 110 may be applied to the SSE layer 116 through the application roller 104 lightly pushing or otherwise placing the conductive layer onto the SSE layer. This may reduce a mechanical strain on the conductive layer 110 and prevent or reduce damage to the fragile conductive layer during the electrode manufacturing process.

At step 210, the interleaf rewind spool 106 may be controlled to continue rotation, thereby causing pulling of the conductive foil 110/interleaf layer 108 from the feeder spool 102 and around the application roller 104. As best illustrated in FIG. 1B, the conductive foil 110 may be applied to the SSE layer 116 of the electrode stack 124 at the application roller 104 as the SSE layer is pulled through the calender press 118 and the conductive foil 110/interleaf layer 108 combination is pulled around the application roller. At step 212, the combined conductive foil 110 and SSE layer 116 may be passed through the calender press 104 as described above to laminate and/or densify the layers of the electrode stack 124. In this manner, the conductive layer 110 may be applied to the electrode stack 124 while reducing a pulling or other mechanical strain on the conductive layer, thereby reducing damage to the conductive foil layer of the manufactured electrode stack.

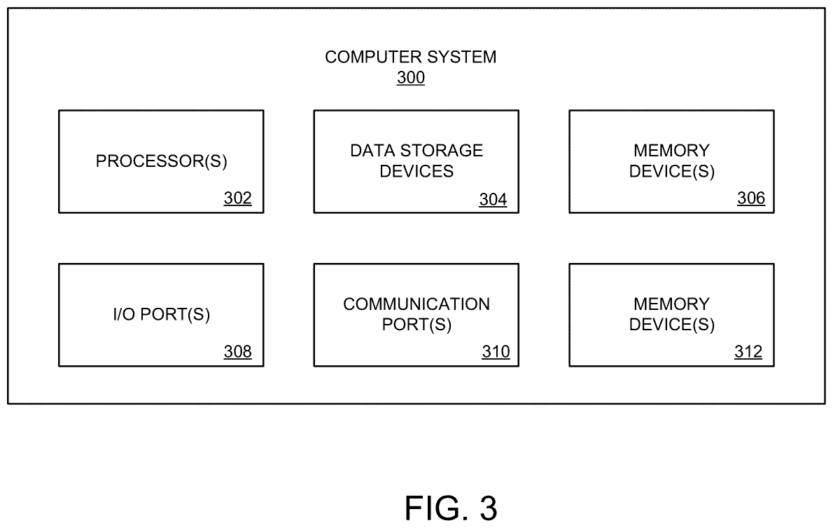

Referring to FIG. 3, a detailed description of an example computing system 300 having one or more computing units that may implement various systems and methods discussed herein is provided. The computing system 300 may be part of the controller 130 of FIG. 1A, may be in operable communication with various implementation discussed herein, may run various operations related to the method discussed herein, and may be part of overall systems discussed herein. The computing system 300 may process various signals discussed herein and/or may provide various signals discussed herein to control the spacing of the calender press, among other settings. It will be appreciated that specific implementations of these devices may be of differing possible specific computing architectures, not all of which are specifically discussed herein but will be understood by those of ordinary skill in the art. It will further be appreciated that the computer system may be considered and/or include an ASIC, FPGA, microcontroller, or other computing arrangement. In such various possible implementations, more or fewer components discussed below may be included, interconnections and other changes made, as will be understood by those of ordinary skill in the art.

The computer system 300 may be a computing system that is capable of executing a computer program product to execute a computer process. Data and program files may be input to the computer system 300, which reads the files and executes the programs therein. Some of the elements of the computer system 300 are shown in FIG. 3, including one or more hardware processors 302, one or more data storage devices 304, one or more memory devices 306, and/or one or more ports 308-312. Additionally, other elements that will be recognized by those skilled in the art may be included in the computing system 300 but are not explicitly depicted in FIG. 3 or discussed further herein. Various elements of the computer system 300 may communicate with one another by way of one or more communication buses, point-to-point communication paths, or other communication means not explicitly depicted in FIG. 3. Similarly, in various implementations, various elements disclosed in the system may or not be included in any given implementation.

The processor 302 may include, for example, a central processing unit (CPU), a microprocessor, a microcontroller, a digital signal processor (DSP), and/or one or more internal levels of cache. There may be one or more processors 302, such that the processor 302 comprises a single central-processing unit, or a plurality of processing units capable of executing instructions and performing operations in parallel with each other, commonly referred to as a parallel processing environment.

The presently described technology in various possible combinations may be implemented, at least in part, in software stored on the data stored device(s) 304, stored on the memory device(s) 306, and/or communicated via one or more of the ports 308-312, thereby transforming the computer system 300 in FIG. 3 to a special purpose machine for implementing the operations described herein.

The one or more data storage devices 304 may include any non-volatile data storage device capable of storing data generated or employed within the computing system 300, such as computer executable instructions for performing a computer process, which may include instructions of both application programs and an operating system (OS) that manages the various components of the computing system 300. The data storage devices 304 may include, without limitation, magnetic disk drives, optical disk drives, solid state drives (SSDs), flash drives, and the like. The data storage devices 304 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 306 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 304 and/or the memory devices 306, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 300 includes one or more ports, such as an input/output (I/O) port 308, a communication port 310, and a sub-systems port 312, for communicating with other computing, network, or vehicle devices. It will be appreciated that the ports 308-312 may be combined or separate and that more or fewer ports may be included in the computer system 300. The I/O port 308 may be connected to an I/O device, or other device, by which information is input to or output from the computing system 300. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 300 via the I/O port 308. In some examples, such inputs may be distinct from the various system and method discussed with regard to the preceding figures. Similarly, the output devices may convert electrical signals received from computing system 300 via the I/O port 308 into signals that may be sensed or used by the various methods and system discussed herein. The input device may be an alphanumeric input device, including alphanumeric and other keys for communicating information and/or command selections to the processor 302 via the I/O port 308.

In one implementation, a communication port 310 may be connected to a network by way of which the computer system 300 may receive network data useful in executing the methods and systems set out herein as well as transmitting information and network configuration changes determined thereby. The communication port 310 connects the computer system 300 to one or more communication interface devices configured to transmit and/or receive information between the computing system 300 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 310 to communicate with one or more other machines, either directly over a point-to-point communication path, over a wide area network (WAN) (e.g., the Internet), over a local area network (LAN), over a cellular (e.g., third generation (3G), fourth generation (4G), fifth generation (5G)) network, or over another communication means.

The computer system 300 may include a sub-systems port 312 for communicating with one or more systems related to a device being charged according to the methods and system described herein to control an operation of the same and/or exchange information between the computer system 300 and one or more sub-systems of the device.

The system set forth in FIG. 3 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

We claim:

1. A system for manufacturing a battery electrode, the system comprising:
a feeder spool containing a conductive foil layer and an interleaf layer;
an application roller receiving the conductive foil layer and the interleaf layer from the feeder spool, the application roller applying the conductive foil layer onto a solid-state electrolyte (SSE) layer of an electrode stack; and
a rewind spool containing a remaining interleaf layer after the conductive foil layer is applied onto the SSE layer;
wherein the conductive foil layer is deposited onto the SSE layer through a gravitational force on the conductive foil layer and a surface energy between the conductive foil layer and the SSE layer.

2. The system of claim 1, wherein the rewind spool is controlled to generate a pulling force on the interleaf layer to remove the interleaf layer from the conductive foil layer as the conductive foil layer is deposited onto the SSE layer by the application roller without tearing of the conductive foil.

3. The system of claim 1 wherein the conductive foil layer is a lithium-based foil.

4. The system of claim 1 wherein the SSE layer comprises a sulfide-based solid electrolyte and a binding material.

5. The system of claim 1 wherein the interleaf layer is a polymer-based material.

6. The system of claim 1, further comprising:
a pressing device, wherein the conductive foil layer is between and adjacent to the SSE layer and a second SSE layer, the pressing device laminating the SSE layer and the second SSE layer to the conductive foil layer.

7. The system of claim 6 wherein the pressing device comprises a calender press.

8. The system of claim 1 wherein the conductive foil layer comprises a surface energy that adheres the conductive foil layer to the SSE layer when brought into contact.

9. The system of claim 1 wherein the rewind spool is rotated to apply a pulling force on the interleaf layer to separate the interleaf layer from the conductive foil layer and to rotate the application roller.

10. The system of claim 7, wherein the application roller is positioned vertically above and horizontally from a lower roller of the calendar press to press the conductive foil layer onto the SSE layer through the gravitational force as the conductive foil contacts the SSE layer.

11. A method for manufacturing a battery electrode, the method comprising:
feeding an interleaf layer comprising a polymer material from a feeder spool, around an application roller, and to a rewind spool, the feeder spool containing a conductive foil layer and the interleaf layer in a layered configuration;
rotating the rewind spool to generate a pulling force on the interleaf layer to remove the interleaf layer as the conductive foil layer is pressed, at the application roller, onto a solid-state electrolyte (SSE) layer of an electrode stack, the conductive foil adhering onto the SSE layer through a gravitational force on the conductive foil layer and a surface energy between the conductive foil layer and the SSE layer; and
passing, while rotating the rewind spool, the conductive foil layer and the SSE layer through a pressing device.

12. The method of claim 11, wherein the pulling force generated by rotating the rewind spool removes the interleaf layer as the conductive foil layer is deposited onto the SSE layer by the application roller without tearing of the conductive foil.

13. The method of claim 11, further comprising:
applying a second SSE layer to the conductive foil layer such that the conductive foil layer is between and adjacent to the SSE layer and the second SSE layer.

14. The method of claim 13, further comprising:
passing the second SSE layer through the pressing device, the pressing device laminating the SSE layer and the second SSE layer to the conductive foil layer.

15. The method of claim 11 wherein rotation of the rewind spool causes rotation of the feeder spool to unwind the layered conductive foil layer and the interleaf layer.

16. The method of claim 11 wherein rotation of the rewind spool causes rotation of the application roller.

17. The method of claim 11 wherein the application roller is constructed from a polymer material, the application roller oriented at least partially vertical of a roller of the pressing device to apply a pressing force on the conductive foil at a location of deposition onto the SSE layer.

18. The method of claim 11 wherein the application roller is constructed from a metal material, the application roller oriented substantially vertical of a roller of the pressing device to apply a pressing force on the conductive foil at a location of deposition onto the SSE layer.

19. A method for manufacturing a battery electrode, the method comprising:
controlling a rotation of a rewind spool to generate a pulling force on an interleaf layer of a conductive foil and interleaf composite in a layered configuration, the conductive foil and interleaf composite contained around a feeder spool and provided to an application roller, wherein the conductive foil and interleaf composite is deposited onto a solid-state electrolyte (SSE) layer of an electrode stack through a gravitational force on the conductive foil and interleaf composite and a surface energy between the conductive foil and interleaf composite and the SSE layer; and
passing, while rotating the rewind spool, the conductive foil and interleaf composite and the SSE layer through a pressing device.

20. The method of claim 19, wherein the pulling force generated by controlling the rotation of the rewind spool removes the interleaf layer as the conductive foil is deposited onto the SSE layer by the application roller.

21. The method of claim 19, further comprising:
applying a second SSE layer to the conductive foil such that the conductive foil is between and adjacent to the SSE layer and the second SSE layer.
